(19) United States
(12) Patent Application Publication
(10) Pub. No.: US 2006/0098445 A1
(43) Pub. Date: May 11, 2006

(54) LIGHT FIXTURE WITH DUAL POSITIONABLE SHADE

(76) Inventors: David M. Lasch, Jacksonville, FL (US); Ambreese Sharif Hill, Jacksonville, FL (US)

Correspondence Address: Dorian B. Kennedy;Baker Donelson Bearman Caldwell & Berkowitz, Suite 900, Five Concourse Parkway, Atlanta, GA, 30328, US

(21) Appl. No.: 10/981,906

(22) Filed: Nov. 5, 2004

(51) Int. Cl. F21V 21/16

(52) U.S. Cl. 362/407; 362/353; 362/449; 362/451

(57) ABSTRACT

A light assembly (10) is disclosed which includes an electric cord (11) coupled to a coupler (12) having a downwardly depending (13) to which a mating fastener (14) is coupled. The combination of the nipple and fastener constitutes a first shade mount. The light assembly also includes a mounting arm (17) extending from the coupler and a light socket assembly (18) coupled to the lower end of the mounting arm. The light socket assembly includes a light socket (19) having an externally threaded portion (21), a conventional light bulb (22), and a second shade mount in the form of an annular support plate (23). The support plate has an opening (24) therein with threads configured to threadably mate with the externally threaded portion of the light socket. A light shade or diffusor may be mounted at an elevated position through the nipple and fastener or at a lower position through the support plate and threaded portion of the light socket assembly.

### TECHNICAL FIELD

This invention relates generally to light fixtures, and more particularly to hanging light fixtures having a shade.

### BACKGROUND OF THE INVENTION

Light fixtures are oftentimes suspended from a ceiling by a length of self supporting SVT electric cord, a cable or a chain. These types of light fixtures may be referred to as pendant lights. Such pendant lights usually include a light shade or diffusor. In the past, these pendant lights were designed to include either a bowl-shaped diffusor which is mounted closely adjacent the light socket or a more traditional cylindrical fabric shade or diffusor which is mounted above the light socket. As these two different types of diffusors utilized vastly different mounting devices for coupling the diffusor to the light assembly, it was nearly impossible to switch between a glass type diffusor and a fabric type diffusor.

Additionally, these two types of diffusers are mounted at different levels relative to the light socket. As such, if one where to change a glass diffusor to a fabric diffusor, or visa-versa, the shade would appear incorrectly positioned with respect to the light socket. As such, light assemblies today are typically designed to be used exclusively with either a bowl type diffusor or a cylindrical type diffusor.

Accordingly, it is seen that a need remains for a light fixture that can accommodate both bowl shaped diffusers and cylindrical diffusers, and especially one which may do so while still presenting an aesthetically pleasing appearance. It is to the provision of such therefore that the present invention is primarily directed.

### SUMMARY OF THE INVENTION

In a preferred form of the invention a light assembly comprises an electrical cord, a mount coupled to the cord, a first fastener portion coupled to the mount, and a second fastener portion removably coupled to the first fastener portion. The first and second fastener portions are configured to hold a conventional light diffusor in a first position. The light assembly also has a mounting arm having one end coupled to the mount, a light socket assembly coupled to the mounting arm opposite the mount, and a support coupled to the light socket assembly and configured to hold a conventional light diffusor in a second position. The support is positioned distally from the first fastener portion. With this construction, a diffusor may be mounted to the light assembly either through the first and second fastener portions or through the support to enable the diffusor to be positioned at two different levels.

### BRIEF DESCRIPTION OF THE DRAWING

FIG. 1 is a perspective view of a pendant light assembly embodying principles of the invention in a preferred form, shown with a cylindrical type light shade.

FIG. 2 is a side view, in partial cross-section, of the pendant light assembly of FIG. 1.

FIG. 3 is a side view, in partial cross-section, of the pendant light assembly of FIG. 1, shown with a bowl type light diffusor.

FIG. 4 is a side view of the pendant light assembly of FIG. 1, shown with two shade in phantom lines.

### DETAILED DESCRIPTION

With reference next to the drawings, there is shown a hanging or pendant light assembly 10 in a preferred form of the invention. The light assembly 10 is adapted to be suspended from a ceiling or the like.

The light assembly 10 includes a SVT electric cord 11 which is electrically coupled to a source of electricity in conventional fashion, such as through a conventional light mounting box and electric conductors. The electric cord 11 has a lower end to which is coupled a conical mount or coupler 12. Coupler 12 includes an externally threaded, downwardly depending rod or nipple 13 to which a mating fastener 14 having corresponding internal threads is threadable coupled. Here, the fastener 14 is shown in the form of a finial, however, it should be understood that any conventionally know type of fastener may be utilized. The combination of the nipple 13 and fastener 14 constitutes a first shade mount which enables a diffusor to be mounted in an elevated position.

The light assembly 10 also includes a mounting arm 17 extending from the coupler 12 and a light socket assembly 18 coupled to the lower end of the mounting arm 17. The mounting arm 17 is generally C-shaped so that the nipple 13 resides within the interior spaced defined by the C-shaped mounting arm 17. The mounting arm 17 is also hollow so that the electrically insulated electrical conductors of electric cord 11 pass therethrough, so that they may be electrically coupled to the light socket assembly 18.

The light socket assembly 18 includes a light socket 19 having an externally threaded portion 21, a conventional light bulb 22, and a second shade mount in the form of an annular support plate 23. The support plate 23 has an opening 24 therein with threads configured to threadably mate with the externally threaded portion 21 of the light socket 19. The support plate enables a diffusor to be mounted in a low position.

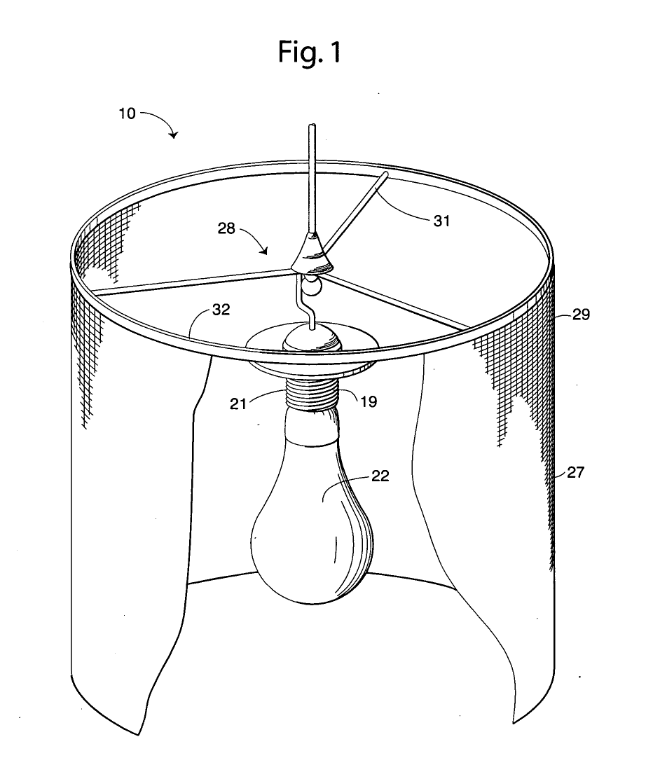

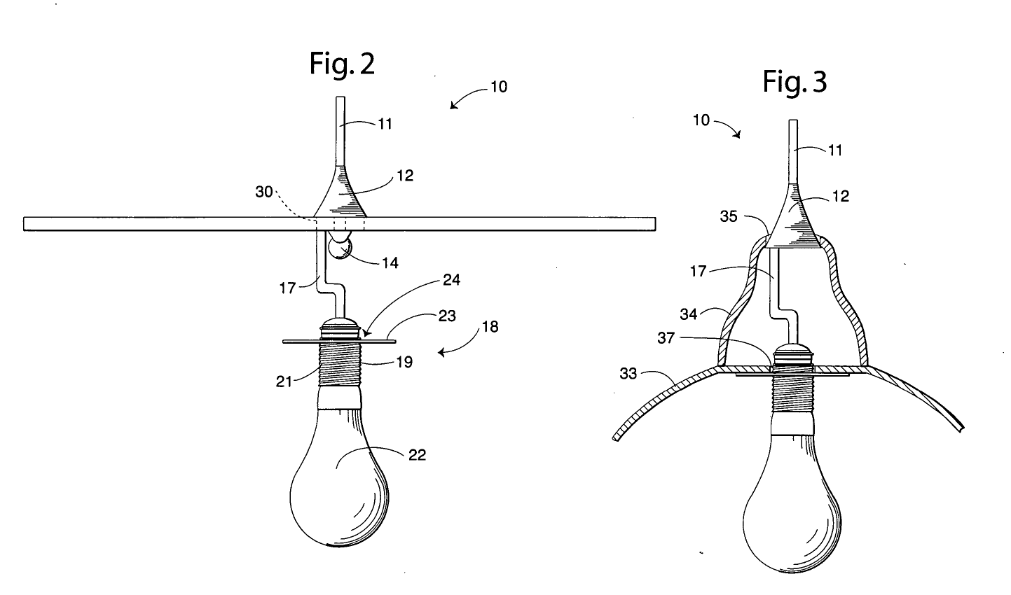

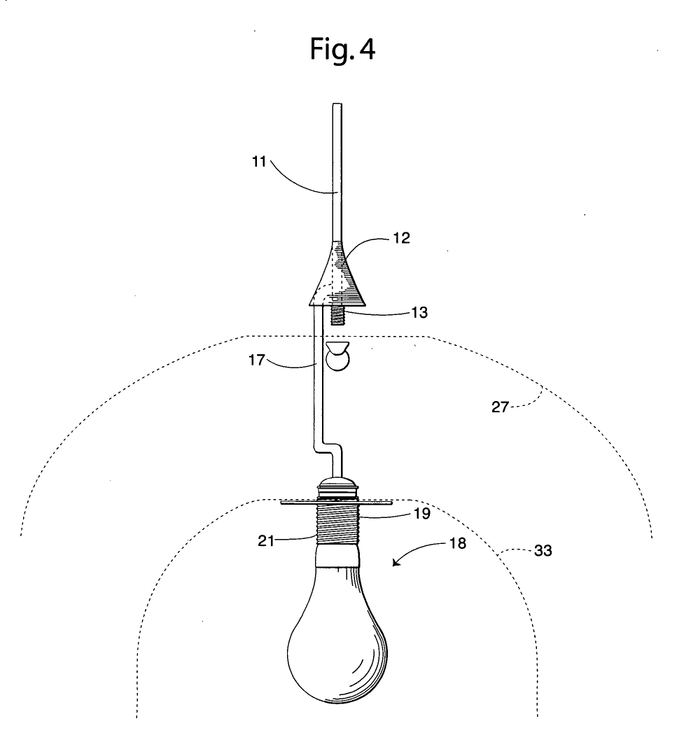

The light assembly 10 may be used with a conventional cylindrical type light shade or diffusor 27 as shown in FIG. 1. Here, the light shade 27 has a central hub or spider 28 and a cylindrical, fabric shade portion 29. The spider 28 has a central, mounting ring 30 from which a radial array of rods or spokes 31 extend to a peripheral rim 32.

To mount this type of light shade 27 to the light assembly first shade mount the fastener 14 is unthreaded from the nipple 13. The light shade mounting ring 30 is then journalled onto the nipple 13 and the fastener 14 is re-threaded onto the nipple 13 to secure the position of the light shade 27.

It should be understood that because of the extended height of this type of light shade the light shade should be mounted in an elevated position distal the light socket assembly 18. This positioning of the light shade allows the light bulb 19 to be positioned centrally within the light shade 27.

With reference next to FIG. 3, alternatively the light assembly 10 may be used for coupling a conventional bowl-shaped light diffusor 33, which may be made of any conventional material such as glass, plastic, metal or the like. Depending upon the exact height and shape of the bowl-shaped light diffusor 33, the diffusor may also include a cover or canopy 34 which is configured to overlay a portion of the light assembly. The cover 34 includes a central opening 35 sized and shaped to be seated upon the lower end of the coupler 12. Here, the light diffusor 33 has a central opening 37 therethrough of a size larger than the threaded portion 21 of the light socket assembly but smaller than the support plate 23.

To mount this type of light diffusor to the light assembly the support plate 23 is unthreaded from the threaded portion 21 of the light socket assembly. The cover 34 is then positioned upon the electric cord 11 and the diffusor 33 is journalled onto the threaded portion 21 of the light socket assembly. The support plate 23 is then re-threaded onto the light socket threaded portion 21 to a position wherein the diffusor 33 is resting upon the support plate 23 at a proper level with respect to the light assembly 10. Once the diffusor is properly positioned upon the support plate, the cover 34 is lowered upon the diffusor and coupler.

It should be understood that because of the shallow height of this type of light shade or diffusor, it should be mounted at a low position closely adjacent the light socket assembly. This positioning of the diffusor allows the light bulb to be positioned centrally within the light shade or diffusor.

It should be understood that the terms diffusor and shade may be used interchangeably herein. It should also be understood that alternatively the light assembly may utilize a chain or cable in conjunction with an electric cord, as an alternative to the self-supporting SVT type electric cord shown in the drawings.

It should also be understood that as an alternative the separate finial and nipple, the first shade mount may utilize a post and fastener that are unitary in construction and adapted to be threaded into the bottom of the coupler 12. As such, one portion of the mount would comprise the post and fastener combination while the other portion of the mount would comprise a threaded part of the coupler.

It thus is seen that a light assembly is now provided which overcomes problems with light assemblies of the prior art by allowing different types and sizes of light diffusers or light shades to be utilized therewith. While this invention has been described in detail with particular references to the preferred embodiments thereof, it should be understood that many modifications, additions and deletions, in addition to those expressly recited, may be made thereto without departure from the spirit and scope of the invention as set forth in the following claims.

1. A light assembly comprising:
an electrical cord;
a mount coupled to said cord;
a first fastener portion coupled to said mount;
a second fastener portion removably coupled to said first fastener portion, said first and second fastener portion being configured to hold a conventional light diffusor in a first position;
a mounting arm having one end coupled to said mount;
a light socket assembly coupled to said mounting arm opposite said mount; and
a support coupled to said light socket assembly and configured to hold a conventional light diffusor in a second position, said support being positioned distally from said first fastener portion,
whereby a diffusor may be mounted to the light assembly either through the first and second fastener portions or through the support to enable the diffusor to be positioned at two different levels.

2. The light assembly of claim 1 wherein said first fastener portion is an externally threaded post and said second fastener portion is an internally threaded fastener mateable with said threaded post.

3. The light assembly of claim 1 wherein said mounting arm is a C-shaped mounting arm defining an interior area and wherein said post is positioned within said interior area defined by said C-shaped mounting arm.

4. The light assembly of claim 1 further comprising a cover configured to overlay said second fastener portion, said mounting arm, and at least a portion of said light socket assembly.

5. The light assembly of claim 1 wherein said light socket assembly includes external threads, and wherein said support includes internal threads configured to mate with said light socket assembly external threads.

6. A light assembly adapted to be suspended from an elevated structure, said light assembly comprising:
a light socket assembly adapted to hold a conventional light bulb;
a mounting arm coupled to said light socket assembly;
a coupler mounted to said mounting arm opposite said light socket assembly;
suspension means coupled to said coupler for suspending said coupler, said mounting arm and said light socket from an elevated structure,
a first shade mount coupled to said coupler;
a second shade mounted coupled to said light socket assembly;
whereby a light diffusor may be coupled to the light assembly by mounting it to the first shade mount at one position or to the second shade mount at another position.

7. The light assembly of claim 6 wherein said first shade mount includes a first fastener portion and a second fastener portion removably coupled to said first fastener portion.

8. The light assembly of claim 7 wherein said first fastener portion is an externally threaded post and said second fastener portion is an internally threaded fastener mateable with said threaded post.

9. The light assembly of claim 8 wherein said mounting arm is a C-shaped mounting arm defining an interior area and wherein said post is positioned within said interior area defined by said C-shaped mounting arm.

10. The light assembly of claim 6 further comprising a cover configured to overlay said coupler, said mounting arm, and at least a portion of said light socket assembly.

11. The light assembly of claim 6 wherein said light socket assembly includes external threads, and wherein said support includes internal threads configured to mate with said light socket assembly external threads.
